(19) United States
(12) Patent Application Publication
(10) Pub. No.: US 2005/0217953 A1
(43) Pub. Date: Oct. 6, 2005

(54) Suspension device with hydraulic shock absorber with selective shock absorbing control

(76) Inventor: Olivier Bossard, Cugnaux (FR)

Correspondence Address: YOUNG & THOMPSON, 745 SOUTH 23RD STREET, 2ND FLOOR, ARLINGTON, VA, 22202, US

(21) Appl. No.: 10/980,427

(22) Filed: Nov. 4, 2004

(30) Foreign Application Priority Data
Mar. 31, 2004 (FR) 04 50636

(51) Int. Cl. F16F 5/00

(52) U.S. Cl. 188/281

(57) ABSTRACT

A suspension device for a wheeled vehicle, includes a shock absorber (105) and a spring (110), disposed between a non-suspended portion of a vehicle and a suspended portion of the vehicle, the shock absorber (105) having a shock absorber body (1) provided with a cylindrical cavity (10) in which slides a piston (2), the piston being connected to a rod (3) leaving the cylindrical cavity through a sealing ring (4), the piston (2) being provided with calibrated elements (5) for passage of a fluid such as an oil from sub-cavity (10a) to a sub-cavity (10b) as a function of the movements of the piston, in response to forces exerted on the suspension, the piston including a discharge device (15), this discharge device being adapted to take a position of opening a conduit between one sub-cavity and the other and a position of closing this conduit.

The present invention relates to a suspension device for a wheeled vehicle with a hydraulic shock absorber for example an automotive vehicle, 2 wheeled vehicle or a cycle. Suspension devices with hydraulic shock absorbers for automotive vehicles comprise generally a spring and a passive hydraulic shock absorber comprising a body in which slides a piston delimiting two chambers, the piston being prolonged by a rod, the spring having a first end secured to the shock absorber body and a second end secured to the rod of the shock absorber.

Conventional systems are such that a fixed shock absorption law is predetermined to absorb oscillations of the spring subjected to the forces of the movement of the vehicle.

Devices permitting varying the shock absorption law dynamically exist, but these devices require electronic management based on complex movement detectors. An active device is for example described in U.S. Pat. No. 5,178,242, which relates to a shock absorber comprising a rotatable blade adapted to take several positions corresponding to different shock absorbing laws as a function of the control of an actuator connected to an electronic device reacting as a function of parameters measured by detectors. Such devices however are slow and complicated and, for example, cannot recover quickly from an abrupt contact of a vehicle wheel with the road for example after compression of the spring because of a rut.

The present invention has for its object to provide a suspension device adapted to change from a given shock absorbing law to another shock absorbing law in a shorter time, particularly during loss of contact of the wheel with the ground.

To do this, the present invention relates principally to a suspension device for a wheeled vehicle, comprising a shock absorber and a spring, disposed between a non-suspended portion of the vehicle and a suspended portion of the vehicle, the shock absorber comprising a shock absorbing body provided with a cylindrical recess in which slides a piston, the piston being connected to a rod extending out the cylindrical cavity through a sealing ring, the piston being provided with calibrated means for passage of a fluid such as oil, from a first sub-cavity to a second sub-cavity delimited by the position of the piston as a function of the movements of the piston, in response to forces exerted on the suspension, the suspension device being such that the piston comprises a discharge device, this discharge device being adapted to assume an open position of a conduit between one sub-cavity and the other, and a closed position of this conduit provided through a control rod, sliding axially within the piston rod and terminating in a movable body and provided with securement means on one of said non-suspended and suspended portions.

The discharge device can particularly comprise a first channel opening into the upper sub-cavity, at least one second channel opening into the lower sub-cavity and a closure system of the passage between the first and second channels, comprising a needle valve resting on a seat when the communication between said first channel and said second channel is closed, the needle valve being spaced from the seat when the communication between the first and second channels is open.

The connection means of the shock absorber rod to the rolling mechanism can particularly comprise a body fixed relative to the shock absorber, constituted by a head secured to the shock absorber rod, and the movable body provided with securement means to the rolling mechanism and movable relative to the shock absorber.

The movable body can comprise a first portion, disposed in a chamber provided in the head secured to the shock absorber rod, adapted to slide in the chamber, between an upper abutment position and a lower abutment position, delimited by an upper wall and a lower wall of the chamber.

More particularly, the chamber can be closed by a screw-threaded plug provided with a central passage to let a second portion of the movable body pass, comprising said securement means.

The screw-threaded plug can comprise an annular bottom which coacts with a surface of the movable body to limit the possibility of play of the movable body.

In a particularly preferred embodiment of the invention, the screw-threaded plug can permit adjusting the path of free movement of the movable body and thus of the discharge device through the control rod, to adjust the quantity of passage of fluid into the discharge device.

More particularly, the discharge device can be such that it remains in a closed position of the conduit for as long as the suspension remains stressed, the discharge device passing to the open position of the conduit upon passage of the suspension to the free mode.

The shock absorber body can be closed on the side opposite the sealing ring by a second head provided with means securing the shock absorber to one of said suspended and non-suspended portions.

The spring can be disposed coaxially to the shock absorber and kept compressed between two annular abutments, one secured to the shock absorber body, the other secured to the shock absorber rod.

According to a particular embodiment of the invention, a compensating element is positioned between the movable body and the shock absorber body, the compensating element opposing a movement of the discharge device to the open position of the conduit.

According to another alternative embodiment, a compensating element is positioned between the movable body and the shock absorbing body, the compensating device favoring the movement of the discharge device to the open position of the conduit.

Preferably, an oscillating arm connects the non-suspended portion of the vehicle to the suspended portion of the vehicle and a compensating device, comprising a rod, fixed at one end to the shock absorbing body and at a second end to an arm articulated on the oscillating arm, and a spring, disposed between said oscillating arm and said rod, exerts an effort to space apart the movable body and the shock absorbing body, favoring the movement of the discharge device to the open position of the conduit.

Other characteristics and advantages of the invention will become apparent from a reading of the description which follows, of a particular and non-limiting embodiment, with reference to the drawings, which represent:

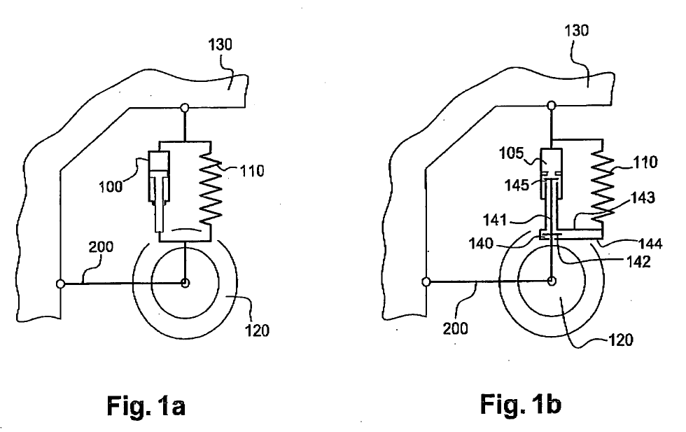

FIG. 1a: A fragmentary schematic view of a vehicle provided with a conventional suspension device;

FIG. 1b: A fragmentary schematic view of a vehicle provided with a suspension device according to the invention;

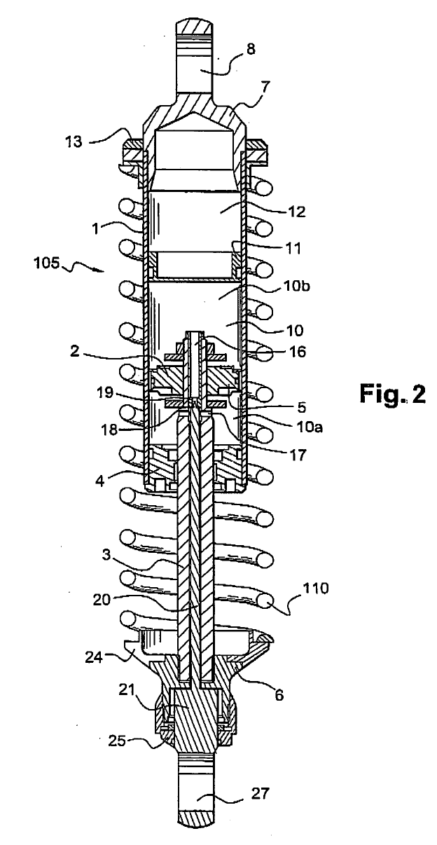

FIG. 2: a longitudinal cross-sectional view of a suspension device according to the invention;

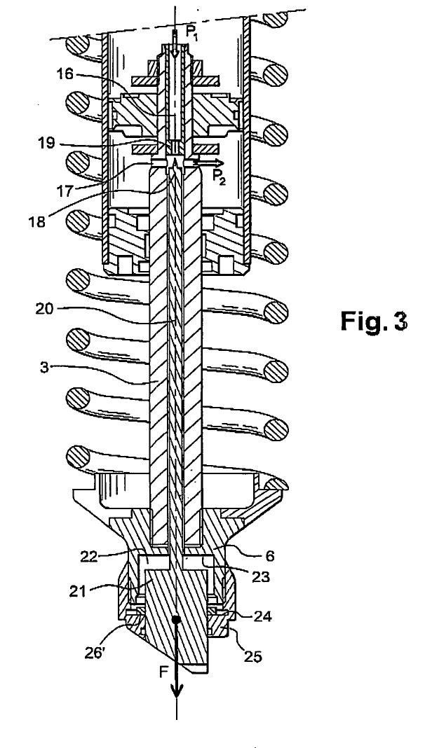

FIG. 3: a fragmentary view of the device of FIG. 2 in the discharge position;

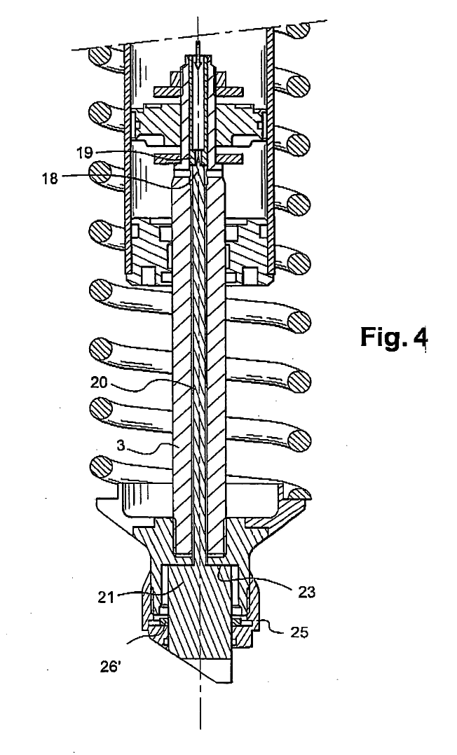

FIG. 4: a fragmentary view of the device of FIG. 2 in the closed position;

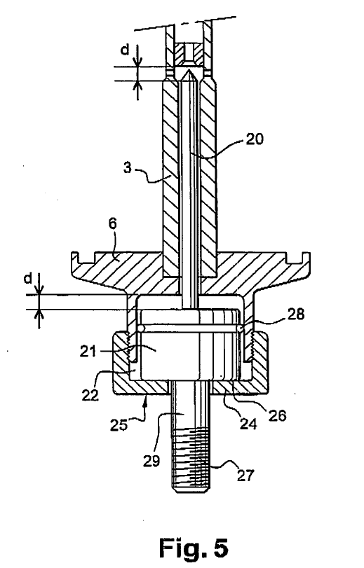

FIG. 5: an enlarged view of a detail of embodiment of the device according to the invention;

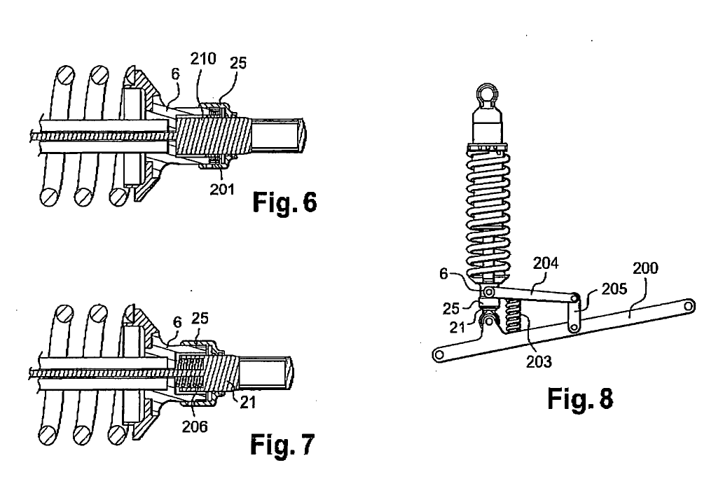

FIG. 6: a view of a detail of a first particular embodiment of the invention;

FIG. 7: a detailed view of a second particular embodiment of the invention;

FIG. 8: a view of a detail of a third particular embodiment of the invention.

A known conventional suspension device, schematically shown in FIG. 1a, comprises a shock absorber 100 and a spring 110 in parallel. Such a shock absorbing device is in known manner disposed between a rolling device 120, or a non-suspended portion of a vehicle, and a suspended portion of the vehicle, for example the body 130 of the vehicle. For a two-wheeled vehicle, the shock absorber can be disposed in a forked tube between the front wheel and the steering column of the vehicle or mounted between the body of the vehicle and an oscillating arm receiving the axle of the rear wheel.

The suspension device according to the invention schematically shown in FIG. 1b comprises a modified shock absorber 105 and a spring 110, again mounted in parallel but connected, in this example, to the rolling portion 120 via a connection member 140 comprising an element 142, movable relative to the spring/shock absorber assembly 105, 110 between an upper abutment 143 and a lower abutment 144, secured mechanically to the rolling device 120, the suspension device moreover comprising a rod 141, secured to the movable element 142 and adapted to control a discharge device 15 internal to the shock absorber 105.

The example of embodiment of the device according to the invention more particularly shown in FIG. 2 comprises in a suspension element combining a shock absorber 105 and a spring 110, here coaxial, usable for any type of vehicle. The illustrated shock absorber 105 comprises a shock absorbing body 1 comprising a cylindrical cavity 10 in which slides a piston 2, the piston being connected to a piston rod 3 exiting the cylindrical cavity through a sealing ring 4. The shock absorber 105 can be mounted vertically in one direction or the other as a function of its use.

The piston 2 is in known manner provided with calibrated means 5 for the passages of a fluid, such as oil, from one sub-cavity 10a to a sub-cavity 10b separated by the piston as a function of the movements of the piston, and this in response to the forces exerted on the suspension. Again in a known manner, the shock absorber as illustrated comprises a floating supplemental piston 11 separating the cavity 10 from a cavity 12 filled with an inert gas.

The body of shock absorber 1 is closed on the side opposite the sealing ring 4 by a head 7 provided with means 8 to secure the shock absorber to an element of the vehicle or to an element of the rolling structure of the vehicle. According to the example, in which the shock absorber is shown with the shock absorber body 1 above the piston rod, the shock absorber body is fixed to the chassis of the vehicle via the upper head 7, whilst the piston rod 3 is connected on a first side to the piston 2 and on a second side to a lower head 6 forming a portion of the connection member to the rolling structure of the vehicle.

Again according to the example, the spring 110 is disposed coaxially to the shock absorber and held compressed between two annular abutments 13, 14 secured one to the upper head 7, the other to the lower head 6.

According to the invention, the shock absorber, in addition to the calibrated means 5 for passage of a fluid, comprises a discharge device 15 connected to the piston 2, this discharge device being adapted to take an open position of a conduit 16, 17 between one sub-cavity and the other, and a closed position of this conduit.

This discharge device comprises a first channel 16 opening into the upper sub-cavity 10b, a second channel 17, if desired provided with multiple branches, opening into the lower sub-channel 10a, and a closure system 18, 19 for the passage between the channels 16, 17. As shown, the closure system comprises a needle valve 18 resting on a seat 19 when the communication between the first channel 16 and the second channel 17 is closed, the needle valve 18 being spaced from the seat 19 when the communication between the first channel 16 and the second channel 17 is open.

The control of the needle valve is effected by a control rod 20. This control rod, which can slide axially within the piston rod 3, terminates in a movable body 21, disposed in a chamber 22 provided in the head 6, adapted to slide in the chamber 22 between another abutment position, in which the upper surface of the movable body 21 comes into abutment against the upper wall 23 of the chamber 22, and a lower abutment position in which the movable body 21 is retained by a screw-threaded plug 25 provided with a central passage closing the bottom of the chamber 22. According to the embodiment shown in FIGS. 2, 3 and 4, the movable body 21 comprises an annular ring 26′ coming into abutment against the lower wall 24 of the chamber constituted by the screw-threaded plug 25.

Thus, the connection means of the shock absorber rod 3 to the rolling structure comprises a body fixed relative to the shock absorber, this fixed body being constituted by the head 6, and a body movable relative to the shock absorber, this movable body being the movable body 21 provided with means 27 for securement to the rolling structure.

The head 6 and the movable body 21 correspond to the connection member 140 comprising an element 142 movable relative to the spring/shock absorber assembly 105, 110.

The operation of the discharge device is as follows:

Upon stopping, the vehicle bears against the rolling structure, the movable body is thus held between the wall 23 closing the chamber 22, the needle valve 18 rests on its seat 19 and the passage between the first and second channels is closed. This position is shown in FIG. 4.

When the vehicle moves and is subject to moderate movements, the suspension remains stressed, such that the spring will be in a compressed phase or in an expanded phase. In this configuration, the wheels of the vehicle remain in contact with the ground, the movable body 21 remains held against the wall 23 closing the chamber 22, the needle valve 18 still rests on its seat 19 and the passage between the first and second channels remains closed.

By contrast, in the case of an abrupt expansion of the shock absorber, after hitting a rut for example, the suspension can pass into a free mode, which is to say that the variation of the ground/vehicle distance will be more rapid and the speed of expansion of the spring damped by the shock absorber. In such a case, for a conventional suspension, the wheel leaves the ground, then the vehicle falls whilst the spring is possibly not yet extended.

On the contrary, for a suspension provided with a device according to the invention, when there is a loss of contact between the wheel and the ground, the rolling mechanism, under its own weight, draws the movable body 21 downwardly in the direction shown by the arrow F in FIG. 3, which, via the control rod 20, disengages the needle valve 18 from the seat 19 and opens the passage P1, P2 between the first and second discharge channels 16, 17, thus permitting a large outflow of fluid from the cavity 10a toward the cavity 10b and thus changing the shock absorption law of the shock absorber 105 toward a weaker law freeing the spring so that it expands more rapidly until the wheel again contacts the ground.

When the loss of contact is minimal, regaining contact of the wheel with the ground immediately closes the passage between the first and second channels. When the loss of contact is more extended, in the case of an all terrain vehicle after going over a bump for example, the suspension is completely extended as fast as possible.

Thus the invention permits providing a shock absorbing control that is selective, between a loaded shock absorbing law and a reduced shock absorbing law in the free mode of the suspension.

The operation of the device depends on the movement of the movable body 21. As previously seen, the screw-threaded plug 25 is to retain the movable body 21 when the suspension is extended and is to let pass the portion of the movable body 21 comprising the securement means 27, either with the rolling structure of the vehicle or a shock absorber positioned with the shock absorber upward, or with the body of the vehicle for an inverted shock absorber.

According to the example shown in FIG. 5 in which the movable body 21 is extended, the screw-threaded plug comprises an annular bottom 24 which coacts directly with a surface 26 of the movable body 21 to limit the possibility of play of the movable body 21 downwardly. According to this example, the movable body 21 comprises a terminal rod 29 of reduced cross-section provided with securement means 27.

The use of a screw-threaded plug to close the chamber 22 permits, by acting on the gripping of the screw-threaded plug 25, adjusting the path of clearance of the movable body 21 and, as a result, adjusting the path “d” of the needle valve 18.

According to this principle, it is possible to adapt the flow rate of the passage of fluid in the discharge device by modification of the maximum distance of movement of the movable body 21 in the extended position corresponding to the free mode of suspension, and hence by adjustment of the maximum movement of the needle valve 18.

The device according to the invention can be improved by the addition of compensating means and particularly FIG. 7 discloses an embodiment in which a compensating device 201, in the form of a spiral spring, secured by a ring 210 to the movable body 21 and bearing against the screw-threaded plug 25, is positioned between the movable body 21 and the shock absorbing body 1, the compensating device opposing movement of the discharge device in the open position of the conduit by pressing the movable body upwardly. According to this principle, a retardation of the opening of the conduit is created for weak stiffness of the spring 201 and, for a greater stiffness of the spring, only an abrupt shock in extension will trigger the opening of the channel.

The example of FIG. 8, on the contrary, is an example in which the compensating device accentuates the opening of the conduit. According to this example, a compensating element 206 in the form of a spiral spring is also positioned between the movable body 21 and the shock absorbing body 1, but this time, the spiral spring is disposed between the head of the movable body 21 and the bottom of the head 6 of the shock absorbing body.

According to this principle, the compensating device 206 favors the movement of the discharge device to the open position of the conduit as soon as the shock absorber is relieved, without achieving the complete passage of the shock absorber to the free mode.

Generally, an oscillating arm 200 or a rod connects the non-suspended portion 120 of the vehicle and the suspended portion 130 of the vehicle. According to the example of FIG. 9, a compensating device is constituted by a lever 204 and a spring 203, the lever 204 is fixed by its first end to the shock absorbing body 1 at the head 6 and by its second end to an arm 205 articulated on the oscillating arm 200.

The spring 203 is disposed between the oscillating arm and the rod, which is to say finally between the movable body 21 fixed on the oscillating arm and the body of the shock absorber 1 via the head 6.

Thus, the spring 203 exerts a separating force between the movable body 21 and the shock absorbing body 1, which promotes the movement of the discharge device to the open position of the conduit when the shock absorber is relieved or when the vehicle wheel leaves the ground.

It should be noted that the system according to the invention also functions for an inverted shock absorber in which the rod 3 is directed upwardly and the shock absorber body 1 is directed downwardly. Thus, in such an arrangement, it is not the movable body 21, fixed to the chassis of the vehicle, which moves, but rather the spring of the shock absorber assembly which follows the movement of the wheel when it leaves the ground. Thus, when the head 6 becomes the upper head, the movable body 21 is similarly changed and also leaves the abutment 23 (in this case the lower abutment for the movable body 21) thereby freeing the passage between the channels 16, 17, which opens the discharge circuit.

For the operation of the system, it is no longer necessary that the shock absorber and the spring be coaxial, the movable body permitting opening the discharge device however should remain outside the spring/shock absorber assembly.

1. Suspension device for a wheeled vehicle, comprising a shock absorber (105) and a spring (110), disposed between a non-suspended portion (120) of the vehicle and a suspended portion (130) of the vehicle, the shock absorber (105) comprising a shock absorber body (1) provided with a cylindrical cavity (10) in which slides a piston (2), the piston being connected to a piston rod (3) leaving the cylindrical cavity through a sealing ring (4), the piston (2) being provided with a calibrated means (5) for passage of a fluid such as an oil, from one sub-cavity (10a) to a sub-cavity (10b) delimited by the position of the piston as a function of movements of the piston, in response to forces exerted on the suspension, characterized in that the piston comprises a discharge device (15), this discharge device being adapted to take an open position of a conduit (16, 17) between one sub-cavity and the other and a closed position of this conduit and in that the control of the discharge device is effected by a control rod (20) sliding axially within the piston rod (3) and terminating in a movable body (21), provided with means (27) for securement on one of said non-suspended (120) and suspended (130) portions.

2. Suspension device according to claim 1, characterized in that the discharge device comprises a first channel (16) opening into the upper sub-cavity (10b), at least one second channel (17) opening into the lower sub-cavity (10a) and a closure system (18, 19) for the passage between the first and second channels (16, 17) comprising a needle valve (18) resting on a seat (19) when the communication between said first channel (16) and said second channel (17) is closed, the needle valve (18) being spaced from the seat (19) when the communication between the first channel (16) and the second channel (17) is open.

3. Device according to claim 1, characterized in that the connection means of the shock absorber rod (3) to the rolling structure comprises a body fixed relative to the shock absorber, this fixed body being constituted by a head (6) secured to the shock absorber rod (3), the movable body (21) being movable relative to the shock absorber and provided with securement means (27) to the rolling structure.

4. Suspension device according to claim 3, characterized in that the movable body (21) comprises a first portion, disposed in a chamber (22) in the head (6) secured to the shock absorber rod (3), adapted to slide in the chamber (22) between an upper abutment position and a lower abutment position, delimited by an upper wall and a lower wall of the chamber.

5. Suspension device according to claim 4, characterized in that the chamber (22) is closed by a screw-threaded plug (25) provided with a central passage to let pass a second portion of the movable body (21) comprising said securement means (27), the screw-threaded plug comprising an annular bottom (24) which coacts with a surface (26) of the movable body (21) to limit the possibility of play of the movable body (21).

6. Suspension device according to claim 5, characterized in that the screw-threaded plug (25) permits adjusting the path of play of the movable body (21) and thus of the discharge device through the control rod (20) to adjust the quantity of passage of fluid into the discharge device.

7. Device according to claim 1, characterized in that the discharge device remains in the closed position of the conduit (16, 17) as long as the suspension remains stressed, the discharge device passing to the open position of the conduit (16, 17) upon passage of the suspension to the free mode.

8. Device according to claim 1, characterized in that the shock absorber body (1) is closed on the side opposite the sealing ring (4) by a second head (7) provided with means (8) securing the shock absorber to one of said suspended (130) and non-suspended (120) portions.

9. Device according to claim 1, characterized in that the spring (110) is disposed coaxially to the shock absorber and held compressed between two annular abutments (13, 14) one secured to the shock absorber body, the other secured to the shock absorber rod.

10. Device according to claim 1, characterized in that a compensating element (201) is positioned between the movable body (21) and the shock absorber body (1), the compensating device opposing a movement of the discharge device to the open position of the conduit.

11. Device according to claim 1, characterized in that a compensating element (206) is positioned between the movable body (21) and the shock absorbing body (1), the compensating device (201) promoting the movement of the discharge device to the open position of the conduit.

12. Device according to claim 1, characterized in that an oscillating arm (200) connects the non-suspended portion (120) of the vehicle and the suspended portion (130) of the vehicle and in that a compensating device, comprising a rod (204), fixed at one end to the shock absorbing body (1) and by a second end to an arm (205) articulated on the oscillating arm (200), and a spring (203), disposed between said oscillating arm and said rod, exerts a separating force between the movable body (21) and the shock absorbing body (1) promoting the movement of the discharge device to the open position of the conduit.

13. Device according to claim 2, characterized in that the connection means of the shock absorber rod (3) to the rolling structure comprises a body fixed relative to the shock absorber, this fixed body being constituted by a head (6) secured to the shock absorber rod (3), the movable body (21) being movable relative to the shock absorber and provided with securement means (27) to the rolling structure.
